(19) United States
(12) Patent Application Publication
(10) Pub. No.: US 2018/0164584 A1
(43) Pub. Date: Jun. 14, 2018

(54) Shift Converter

(71) Applicant: Anhui Changgeng Optics Technology Co., LTD, Anhui (CN)

(72) Inventor: Xiaohua ZHANG, Kunshan City (CN)

(21) Appl. No.: 15/588,164

(22) Filed: May 5, 2017

(30) Foreign Application Priority Data
Dec. 8, 2016 (CN) 201610664312.1

(51) Int. Cl. G02B 27/00; G02B 15/02

(52) U.S. Cl. CPC G02B 27/0025; G02B 15/02

(57) ABSTRACT

A shift converter relates to the field of camera lens technologies, and sequentially comprises, from an object side to an image side, a first lens group G1 having a positive diopter and a second lens group G2 having a negative diopter; when a focal length of the first lens group G1 is F1, a focal length of the second lens group is F2, and a focal length of the whole shift converter is F, the following conditional expression is met: 1.0≤|F1/F2|≤4.5 (1). The Invention can provide a shift converter which is connected on an image space side of a lens of a single-lens reflex camera, small in size, low in costs, good in performance, and strong in universality, and turns an ordinary lens into a tilt-shift lens.

### FIELD OF THE INVENTION

The Invention relates to a converter connected behind a lens and capable of magnifying an image field range, which is especially applicable between a lens and a camera body of a single-lens reflex camera, and can realize an effect of proportionally magnifying an image circle range while extending a focal length.

### BACKGROUND OF THE INVENTION

Currently, a commonly known teleconverter lens connected on the side of an image space of a lens can only extend the focal length but cannot effectively magnify an imaging range, or cannot ensure performance after the imaging range is magnified. The commonly known Japanese Patent Publication No. 2011-112725 conveniently realizes the effect of increasing the focal length, but cannot ensure the imaging performance after the imaging range is magnified. In this case, when the lens and the camera body translate, the imaging range becomes insufficient, and cannot achieve a tilt-shift function to eliminate a perspective distortion problem caused by photographing.

### SUMMARY OF THE INVENTION

In view of the problem that an existing teleconverter lens can only extend a focal length but cannot ensure the magnification of an imaging range, the Invention provides a converter that can magnify the imaging range while extending the focal length, so that situations such as vignetting and black edging do not occur even when the lens and the camera body have translation dislocation, and this is equivalent to a function of a tilt-shift lens, which eliminates a perspective distortion problem caused by photographing.

The following technical solution is employed to solve the technical problem:

A shift converter sequentially includes, from an object side to an image side, a first lens group G1 having a positive diopter and a second lens group G2 having a negative diopter; when a focal length of the first lens group G1 is F1, a focal length of the second lens group is F2, and a focal length of the whole shift converter is F, the following conditional expression is met:

1.0≤|F1/F2|≤4.5 (1).

The following conditional expression is met:

0.8≤|F1/F|≤3.0 (2).

The following conditional expression is met:

0.3≤|F2/F|≤1.0 (3).

The following conditional expression is met:

1.2≤|Y1/Y|≤1.6 (4)

where,

Y: a maximum paraxial image height of a lens;

Y1: a maximum paraxial image height after the lens is combined with the shift converter.

The following conditional expression is met:

0.65≤|Y/BF|≤50.9 (5)

where,

BF: a distance from a surface on a side, which is closest to an image, of the converter to the image after the lens is combined with the shift converter.

The shift converter and the lens are used in coordination, and the magnification of an image and translation of a camera body in a direction perpendicular to an optical axis meet the following conditional expression

0.2≤S/Y1≤0.4 (6)

where,

S: a maximum shift amount after the lens is combined with the shift converter; and

Y1: a maximum paraxial image height after the lens is combined with the shift converter.

The conditional expressions are explained as follows:

If an upper limit of the conditional expression (1) is exceeded, the diopter of a front part of the converter is very weak, and the diopter of a rear group is very strong; although it is extremely easy to achieve a magnifying power, the excessive magnification leads to occurrence of various aberrations, making it hard to ensure the performance. If a lower limit of the conditional expression (1) is exceeded, the magnifying power of the converter is too small; although the performance can be achieved easily, a desired picture size cannot obtained.

If an upper limit of the conditional expression (2) is exceeded, the diopter of the front part of the converter is very weak, and a capability of correcting aberrations in a whole optical system is too weak; although it is extremely easy to achieve the magnifying power, the excessive magnification leads to occurrence of various aberrations, making it hard to ensure the performance. If a lower limit of the conditional expression (2) is exceeded, the aberration correction capability of the front group G1 of the converter is very strong, and due to excessive condensation, it is very difficult to achieve the desired picture area.

If an upper limit of the conditional expression (3) is exceeded, the diopter of the rear group of the converter is very weak; although very small aberrations are generated in the whole optical system and it is easy to ensure the performance, the magnifying power is limited and the desired picture area cannot be achieved. If a lower limit of the conditional expression (3) is exceeded, the magnifying power of the rear group of the converter easily meets the requirement, but it is extremely difficult to correct aberrations caused by excessive magnification, and the performance cannot be ensured.

If an upper limit of the conditional expression (4) is exceeded, despite that the picture area after magnification is large enough, the performance cannot be ensured, and it is difficult to correct aberrations. If a lower limit of the conditional expression (4) is exceeded, although the performance can be ensured easily, the magnified picture cannot meet a requirement of vertical shifting.

If an upper limit of the conditional expression (5) is exceeded, a back focal length is excessively small after the lens is combined with the converter, a space for implementing a tilt-shift mechanism in a mechanical structure is too small, making commercialization extremely difficult. If a lower limit of the conditional expression (5) is exceeded, although the performance can easily ensure the space of the back focal length, due to an excessively large space, an optical structure is complex, and the performance cannot be implemented.

If an upper limit of the conditional expression (6) is exceeded, although a relatively large shift amount can be achieved, an excessive translation amount makes it hard to ensure the performance of an image edge. If a lower limit of the conditional expression (6) is exceeded, image quality of the edge can be ensured, but due to an insufficient amount of movement, an effect of removing a perspective distortion by tilt-shift cannot be achieved.

The Invention has the following beneficial effects: the Invention can provide a shift converter which is connected on an image space side of a lens of a single-lens reflex camera, small in size, low in costs, good in performance, and strong in universality, and turns an ordinary lens into a tilt-shift lens.

### BRIEF DESCRIPTION OF THE DRAWINGS

FIG. 1 is a schematic view of a status in which the Invention is in coordination with a lens;

FIG. 2 is a schematic structural view of Example 1 of the Invention in coordination with a lens;

FIG. 3 is a schematic view of a spherical aberration, a field curvature aberration, a distortion aberration, and a chromatic difference of magnification according to Example 1 of the Invention;

FIG. 4 is a schematic structural view of Example 2 of the Invention in coordination with a lens;

FIG. 5 is a schematic view of a spherical aberration, a field curvature aberration, a distortion aberration, and a chromatic difference of magnification according to Example 2 of the Invention;

FIG. 6 is a schematic structural view of Example 3 of the Invention in coordination with a lens; and

FIG. 7 is a schematic view of a spherical aberration, a field curvature aberration, a distortion aberration, and a chromatic difference of magnification according to Example 3 of the Invention.

### DETAILED DESCRIPTION OF THE INVENTION

To make the technical measures, creation features, and achieved objectives and effects of the Invention easy to understand, the following further illustrates the Invention with reference to specific drawings.

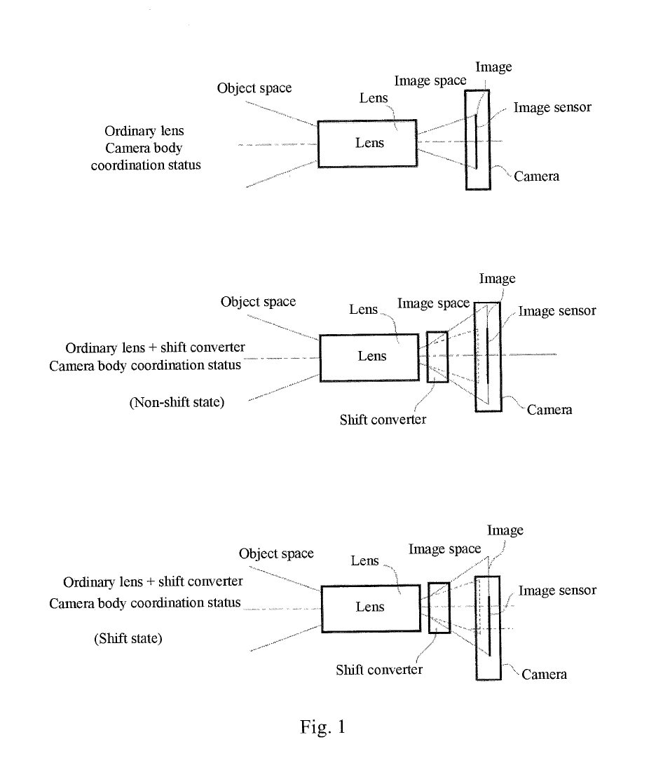

As shown in FIG. 1, a shift converter is in coordination with a lens (i.e., an ordinary lens).

### Example 1

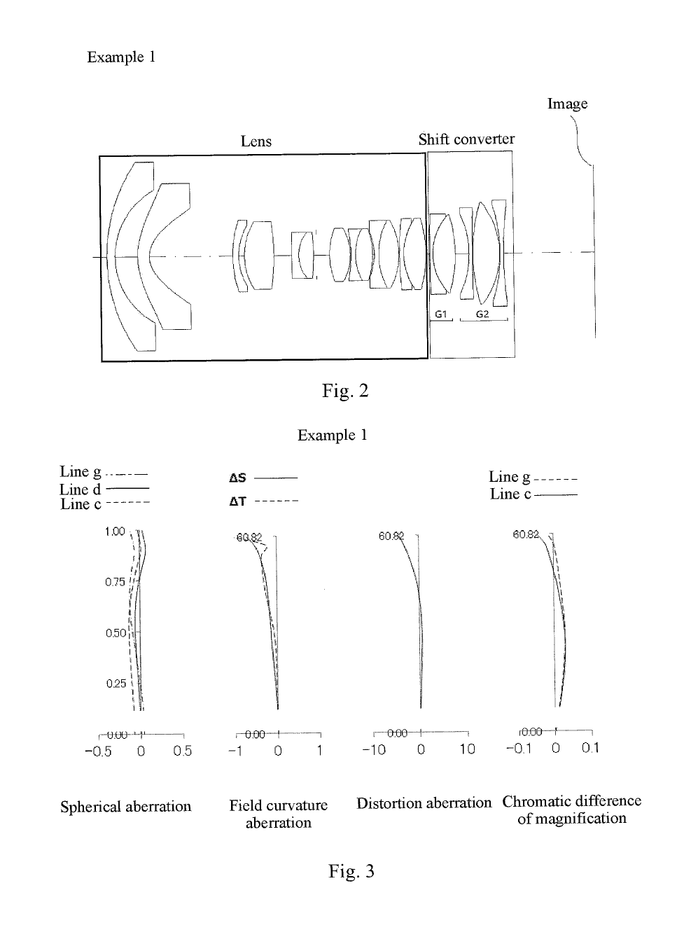

As shown in FIG. 2, a shift converter of Example 1 is connected on an image space side of a lens, and sequentially includes, from an object side, a first lens group G1 having a positive diopter and a second lens group G2 having a negative diopter. A spherical aberration, a field curvature aberration, a distortion aberration, and a chromatic difference of magnification in Example 1 are as shown in FIG. 3.

Data of Example 1 is as follows:

R(mm): a radius of curvature of each surface
D(mm): the price and thickness of each lens
Nd: a refractive index of each glass of line d
Vd: the Abbe number of glass
Focal length: 12.794 (lens) 17.7851 (after combination)
FNo: 2.90 (lens) 4.03 (after combination)
Half angle of view: 60.82
Maximum paraxial image height: 22.91 (lens) 31.85 (after combination)
Maximum translation amount: 11

| NS | R | D | Nd | Vd |
|---|---|---|---|---|
| 1 | 57.2255 | 2.8000 | 1.83481 | 42.72 |
| 2 | 25.9941 | 7.5612 | | |
| 3 ASPH | 22.5399 | 4.0000 | 1.53116 | 56.04 |
| 4 ASPH | 8.5485 | D(4) | | |
| 5 | 38.6168 | 2.0000 | 1.61800 | 63.39 |
| 6 | 19.4304 | 2.0124 | | |
| 7 | 22.3565 | 10.0000 | 1.69895 | 30.05 |
| 8 | −69.4412 | D(8) | | |
| 9 | 0.0000 | 2.3300 | 1.91082 | 35.25 |
| 10 | 12.0308 | 5.0000 | 1.48749 | 70.44 |
| 11 | −64.8524 | 1.0000 | | |
| 12 STOP | 0.0000 | 4.4734 | | |
| 13 | 24.5164 | 7.0000 | 1.48749 | 70.44 |
| 14 | −18.6202 | 0.2000 | | |
| 15 | −44.3466 | 1.5000 | 1.91082 | 35.25 |
| 16 | 18.3061 | 5.8200 | 1.92286 | 20.88 |
| 17 | −25.2406 | 0.5505 | | |
| 18 | −19.4024 | 1.5000 | 1.90366 | 31.31 |
| 19 | 24.5228 | 6.8000 | 1.61800 | 63.39 |
| 20 | −24.5228 | 0.2000 | | |
| 21 | 100.7287 | 1.5000 | 1.92286 | 20.88 |
| 22 | 21.5680 | 7.5000 | 1.61800 | 63.39 |
| 23 | −44.1851 | 1.4000 | (combination interval) | |
| 23 | | 38.7300 | (back focal length of the lens) | |
| 24 | 442.2811 | 1.0000 | 1.90366 | 31.31 |
| 25 | 19.4287 | 7.6000 | 1.74077 | 27.76 |
| 26 | −47.4524 | 4.6499 | | |
| 27 | −32.7599 | 1.2000 | 1.89800 | 34.01 |
| 28 | 566.7445 | 0.1500 | | |
| 29 | 62.0000 | 9.0000 | 1.56732 | 42.84 |
| 30 | −28.5237 | 0.1500 | | |
| 31 | −55.8327 | 1.2000 | 1.83400 | 37.34 |

| | | | |
|---|---|---|---|
| 32 | 132.8471 | 30.6000 | (BF, back focal length after |
| | | | combination) |

### [Aspheric Coefficients]

Definitions of Aspheric Shapes:

$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$

| ASPH | K | 4(B) | 6(C) | 8(D) | 10(E) | 12(F) |
|---|---|---|---|---|---|---|
| 3 | −0.3181 | −3.44340e−005 | 4.15833e−008 | −8.45095e−011 | 9.99078e−014 | −7.78998e−017 |
| 4 | −0.8183 | −4.78042e−005 | −1.08444e−007 | −7.95739e−011 | 5.04510e−013 | −2.13377e−015 |

y: a radial coordinate starting from an optical axis.
z: an offset amount, starting from an intersection between an aspheric surface and the optical axis, in an optical axis direction.
r: a radius of curvature of a reference sphere of the aspheric surface.
K: aspheric coefficients of the 4^{th}, 6^{th}, 8^{th}, 10^{th}, and 12^{th} powers.

### Example 2

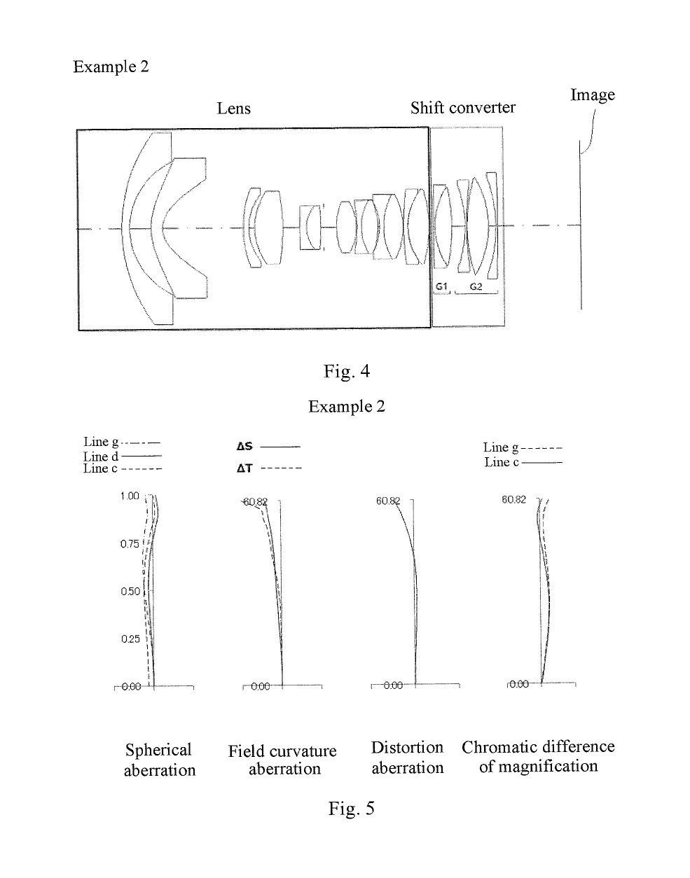

As shown in FIG. 4, a shift converter of Example 2 is connected on an image space side of a lens, and sequentially includes, from an object side, a first lens group G1 having a positive diopter and a second lens group G2 having a negative diopter.

A spherical aberration, a field curvature aberration, a distortion aberration, and a chromatic difference of magnification in Example 2 are as shown in FIG. 5.

Data of Example 2 is as follows:

Focal length: 12.794 (lens) 16.8827 (after combination)
FNo: 2.90 (lens) 3.83 (after combination)
Half angle of view: 60.82
Maximum paraxial image height: 22.91 (lens) 29.846 (after combination)
Maximum translation amount: 10

| NS | R | D | Nd | Vd |
|---|---|---|---|---|
| 1 | 57.2255 | 2.8000 | 1.83481 | 42.72 |
| 2 | 25.9941 | 7.5612 | | |
| 3 ASPH | 22.5399 | 4.0000 | 1.53116 | 56.04 |
| 4 ASPH | 8.5485 | D(4) | | |
| 5 | 38.6168 | 2.0000 | 1.61800 | 63.39 |
| 6 | 19.4304 | 2.0124 | | |
| 7 | 22.3565 | 10.0000 | 1.69895 | 30.05 |
| 8 | −69.4412 | D(8) | | |
| 9 | 0.0000 | 2.3300 | 1.91082 | 35.25 |
| 10 | 12.0308 | 5.0000 | 1.48749 | 70.44 |
| 11 | −64.8524 | 1.0000 | | |
| 12 STOP | 0.0000 | 4.4734 | | |
| 13 | 24.5164 | 7.0000 | 1.48749 | 70.44 |
| 14 | −18.6202 | 0.2000 | | |
| 15 | −44.3466 | 1.5000 | 1.91082 | 35.25 |
| 16 | 18.3061 | 5.8200 | 1.92286 | 20.88 |
| 17 | −25.2406 | 0.5505 | | |
| 18 | −19.4024 | 1.5000 | 1.90366 | 31.31 |
| 19 | 24.5228 | 6.8000 | 1.61800 | 63.39 |
| 20 | −24.5228 | 0.2000 | | |
| 21 | 100.7287 | 1.5000 | 1.92286 | 20.88 |
| 22 | 21.5680 | 7.5000 | 1.61800 | 63.39 |
| 23 | −44.1851 | 1.4000 | (combination interval) | |
| 23 | | 38.7300 | (back focal length of the lens) | |
| 24 | 449.1240 | 0.6000 | 1.90366 | 31.31 |
| 25 | 25.4290 | 5.9442 | 1.74077 | 27.76 |
| 26 | −67.4079 | 4.6831 | | |
| 27 | −43.2214 | 0.6000 | 1.91082 | 37.25 |
| 28 | 125.2528 | 0.1500 | | |
| 29 | 60.3226 | 7.4903 | 1.56732 | 42.84 |
| 30 | −34.5402 | 2.5510 | | |
| 31 | −51.8322 | 0.6000 | 1.83400 | 37.34 |

| | | | |
|---|---|---|---|
| 32 | −578.8036 | 29.000 | (BF, back focal length after |
| | | | combination) |

### [Aspheric Coefficients]

| ASPH | K | 4(B) | 6(C) | 8(D) | 10(E) | 12(F) |
|---|---|---|---|---|---|---|
| 3 | −0.3181 | −3.44340e−005 | 4.15833e−008 | −8.45095e−011 | 9.99078e−014 | −7.78998e−017 |
| 4 | −0.8183 | −4.78042e−005 | −1.08444e−007 | −7.95739e−011 | 5.04510e−013 | −2.13377e−015 |

### Example 3

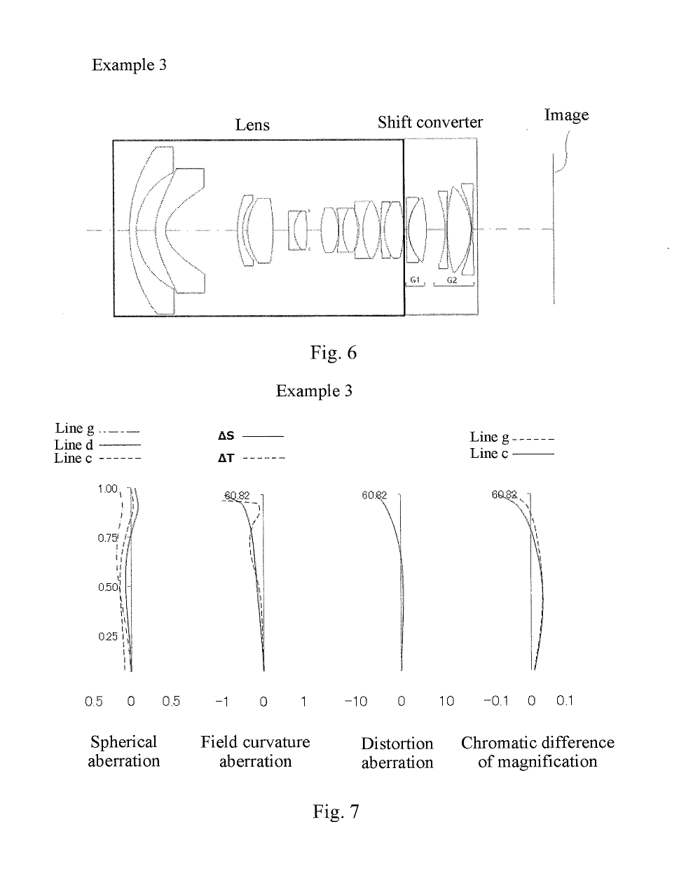

As shown in FIG. 6, a shift converter of Example 3 is connected on an image space side of a lens, and sequentially includes, from an object side, a first lens group G1 having a positive diopter and a second lens group G2 having a negative diopter.

A spherical aberration, a field curvature aberration, a distortion aberration, and a chromatic difference of magnification in Example 3 are as shown in FIG. 7.

Data of Example 3 is as follows:

R(mm): a radius of curvature of each surface
D(mm): the price and thickness of each lens
Nd: a refractive index of each glass of line d
Vd: the Abbe number of glass
Focal length: 12.794 (lens) 18.9251 (after combination)
FNo: 2.90 (lens) 4.29 (after combination)
Half angle of view: 60.82
Maximum paraxial image height: 22.91 (lens) 33.89 (after combination)
Maximum translation amount: 12

| NS | R | D | Nd | Vd |
|---|---|---|---|---|
| 1 | 57.2255 | 2.8000 | 1.83481 | 42.72 |
| 2 | 25.9941 | 7.5612 | | |
| 3 ASPH | 22.5399 | 4.0000 | 1.53116 | 56.04 |
| 4 ASPH | 8.5485 | D(4) | | |
| 5 | 38.6168 | 2.0000 | 1.61800 | 63.39 |
| 6 | 19.4304 | 2.0124 | | |
| 7 | 22.3565 | 10.0000 | 1.69895 | 30.05 |
| 8 | −69.4412 | D(8) | | |
| 9 | 0.0000 | 2.3300 | 1.91082 | 35.25 |
| 10 | 12.0308 | 5.0000 | 1.48749 | 70.44 |
| 11 | −64.8524 | 1.0000 | | |
| 12 STOP | 0.0000 | 4.4734 | | |
| 13 | 24.5164 | 7.0000 | 1.48749 | 70.44 |
| 14 | −18.6202 | 0.2000 | | |
| 15 | −44.3466 | 1.5000 | 1.91082 | 35.25 |
| 16 | 18.3061 | 5.8200 | 1.92286 | 20.88 |
| 17 | −25.2406 | 0.5505 | | |
| 18 | −19.4024 | 1.5000 | 1.90366 | 31.31 |
| 19 | 24.5228 | 6.8000 | 1.61800 | 63.39 |
| 20 | −24.5228 | 0.2000 | | |
| 21 | 100.7287 | 1.5000 | 1.92286 | 20.88 |
| 22 | 21.5680 | 7.5000 | 1.61800 | 63.39 |
| 23 | −44.1851 | 1.4000 | (combination interval) | |
| 23 | | 38.7300 | (back focal length of the lens) | |
| 24 | −886.0180 | 0.6000 | 1.90366 | 31.31 |
| 25 | 18.9140 | 7.0839 | 1.74077 | 27.76 |
| 26 | −52.6932 | 7.3998 | | |
| 27 | −39.5288 | 0.6000 | 1.91082 | 37.25 |
| 28 | 352.6285 | 0.1500 | | |
| 29 | 65.6076 | 9.3469 | 1.56732 | 42.84 |
| 30 | −25.9424 | 0.1500 | | |
| 31 | −40.0496 | 0.6000 | 1.83400 | 37.34 |

| | | | |
|---|---|---|---|
| 32 | 544.0579 | 31.6137 | (BF, back focal length after |
| | | | combination) |

### [Aspheric Coefficients]

| ASPH | K | 4(B) | 6(C) | 8(D) | 10(E) | 12(F) |
|---|---|---|---|---|---|---|
| 3 | −0.3181 | −3.44340e−005 | 4.15833e−008 | −8.45095e−011 | 9.99078e−014 | −7.78998e−017 |
| 4 | −0.8183 | −4.78042e−005 | −1.08444e−007 | −7.95739e−011 | 5.04510e−013 | −2.13377e−015 |

(Summary table of conditional expressions)

| Conditional expression | Example 1 | Example 2 | Example 3 |
|---|---|---|---|
| Conditional expression (1): | 2.180 | 2.495 | 3.466 |
| 1.0 ≤ \|F1/F2\| ≤ 4.5 | | | |
| Conditional expression (2): | 1.129 | 1.428 | 2.470 |
| 0.8 ≤ \|F1/F\| ≤ 3.0 | | | |
| Conditional expression (3): | 0.518 | 0.572 | 0.713 |
| 0.3 ≤ \|F2/F\| ≤ 1.0 | | | |
| Conditional expression (4): | 1.390 | 1.303 | 1.479 |
| 1.2 ≤ Y1/Y ≤ 1.6 | | | |
| Conditional expression (5): | 0.748 | 0.789 | 0.724 |
| 0.6 ≤ Y/BF ≤ 0.9 | | | |
| Conditional expression (6): | 0.345 | 0.335 | 0.355 |
| 0.2 ≤ S/Y1 ≤ 0.4 | | | |

Basic principles and main features of the Invention as well as advantages of the Invention are shown and described above. Those skilled in the art should understand that the Invention is not limited to the foregoing examples. The above examples and the description in the specification are merely used for illustrating the principle of the Invention, and the Invention may further have various changes and improvements without departing from the spirit and scope of the Invention. All these changes and improvements fall in the protection scope of the Invention. The protection scope of the Invention is defined by the appended claims and equivalencies thereof.

1. A shift converter, sequentially comprising, from an object side to an image side, a first lens group G1 having a positive diopter and a second lens group G2 having a negative diopter, wherein when a focal length of the first lens group G1 is F1, a focal length of the second lens group is F2, and a focal length of the whole shift converter is F, the following conditional expression is met:
1.0≤|F1/F2|≤4.5 (1).

2. The shift converter according to claim 1, wherein the following conditional expression is met:
0.8≤|F1/F|≤3.0 (2).

3. The shift converter according to claim 1, wherein the following conditional expression is met:
0.3≤|F2/F|≤1.0 (3).

4. The shift converter according to claim 1, wherein the following conditional expression is met:
1.2≤|Y1/Y|≤1.6 (4)
wherein,
Y: a maximum paraxial image height of a lens; and
Y1: a maximum paraxial image height after the lens is combined with the shift converter.

5. The shift converter according to claim 4, wherein the following conditional expression is met:
0.65≤|Y/BF|≤50.9 (5)
wherein,
BF: a distance from a surface on a side, which is closest to an image, of the converter to the image after the lens is combined with the shift converter.

6. The shift converter according to claim 1, wherein the shift converter and the lens are used in coordination, and the magnification of an image and translation of a camera body in a direction perpendicular to an optical axis meet the following conditional expression:
0.2≤S/Y1≤0.4 (6)
wherein,
S: a maximum shift amount after the lens is combined with the shift converter; and
Y1: a maximum paraxial image height after the lens is combined with the shift converter.

7. The shift converter according to claim 2, wherein the following conditional expression is met:
0.3≤|F2/F|≤1.0 (3).
